(19) United States
(12) Patent Application Publication
(10) Pub. No.: US 2005/0172111 A1
(43) Pub. Date: Aug. 4, 2005

(54) Automatic determination of geometric translation parameters for a disk device

(76) Inventors: Scott B. Marcak, Cypress, TX (US); Mark A. Piwonka, Tomball, TX (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/769,248

(22) Filed: Jan. 30, 2004

(51) Int. Cl. G06F 9/00

(52) U.S. Cl. 713/1

(57) ABSTRACT

Software image portability may be achieved automatically: A host computer reads geometric parameters from a data structure in a boot record of a disk device containing a software image. The computer adopts those parameters as geometric translation parameters for use when accessing the software image. This may be done without the need for intervention by a computer user. In one implementation, the host computer reads the Master Boot Record from the disk device; finds a usable entry in the partition table of the Master Boot Record; reads a sector specified by the Starting LBA field in the usable partition table entry; assigns a number of sectors per track equal to the word found at offset 18h in the BIOS Parameter Block of the sector; and assigns a number of heads equal to the word found at offset 1Ah in the BIOS Parameter Block of the sector.

### FIELD OF THE INVENTION

This invention relates generally to computer system software, firmware or hardware, and more particularly to computer system software, firmware or hardware for supporting the use of disk-type storage devices.

### BACKGROUND

Disk-Type Storage Devices and CHS Addressing. Most computer systems make use of one or more disk-type storage devices. For example, a hard drive is a disk-type storage device based on one or more rotating platters of magnetic media organized into cylinders and sectors. Moveable heads located adjacent to surfaces of the rotating media are used to read data from or write data to the media.

It is possible to access such a disk-type storage device by specifying a particular cylinder, head and sector (a “CHS address”) from which data are to be read or to which data are to be written. Indeed, industry standards exist for doing so. One such standard is defined by interrupt 13h service routines that are exported by basic input output services (“BIOS”) firmware. Another such standard is the ATA/ATAPI specification for interfacing host systems and storage devices. In a typical computer, a disk controller implements the ATA interface, while BIOS firmware implements the interrupt 13h interface. Many disk access requests from client software such as the operating system must traverse both interfaces: The client software issues an access request to the BIOS using the interrupt 13h interface, and the BIOS issues a corresponding request to the disk controller using the ATA interface.

BIOS Geometry Translation. As it happens, the interrupt 13h interface and the ATA interface are not consistent with each other regarding allowable maxima for the components of a CHS address. The interrupt 13h interface allows at most 1024 cylinders, 256 heads and 63 sectors per track—a theoretical address space of 8.4 GB at 512 bytes per sector. The ATA interface allows at most 65536 cylinders, 16 heads and 255 sectors per track—a theoretical address space of 136.9 GB at 512 bytes per sector. Because some disk access requests must traverse both interfaces, usable CHS addresses constitute only those whose CHS components do not exceed the allowable maxima of either the interrupt 13h interface or the ATA interface. Thus, usable CHS addresses are limited to 1024 cylinders, 16 heads and 63 sectors per track. This yields a practical disk drive address space of 528 MB at 512 bytes per sector.

While the 528 MB limit was acceptable at one time, disk technology has developed such that the storage capacity of modern disks far exceeds 528 MB. To work around this problem while still using the interrupt 13h services, a set of techniques known as BIOS geometry translation have been developed.

When BIOS geometry translation is employed, the CHS address used at the interrupt 13h interface is an encoded version of the address used at the ATA interface. This is true regardless of whether the address used at the ATA interface is a CHS-style address or whether it is a newer, flat, logical block address (“LBA”). In either case, the purpose of using an encoded CHS address at the interrupt 13h interface is to make the full 8.4 GB capacity of the interrupt 13h interface available when accessing the disk. This result is accomplished because each component of an encoded CHS address fits within a corresponding bit field defined by the interrupt 13h interface. By way of contrast, the components of an unencoded CHS address for a large disk device generally would not fit within the interrupt 13h bit fields. The encoding is done transparently to client software; it is the responsibility of the BIOS to translate between the encoded CHS addresses passed via the interrupt 13h interface and the unencoded addresses used at the ATA interface.

The Software Image Portability Problem. Unfortunately, no formal standards exist regarding how BIOS geometry translation should be done, and numerous methods exist for accomplishing geometry translation. Consequently, BIOS firmware varies from one manufacturer to another as to the exact nature of the translation algorithms they employ. In addition, even the BIOS from a single manufacturer can employ a variety of different geometry translations depending on the CMOS settings it has been told to assume.

This has created a disk drive interchange problem. Specifically, boot failures occur when a disk drive is moved from an original system where its partitions were defined to a new system whose BIOS geometry translation is different from that of the original system.

The disk drive interchange problem is felt particularly keenly by large organizations that must maintain a heterogeneous set of computers purchased over a number years from a variety of vendors. Such organizations strive to minimize the differences between their computers in order to reduce demands on their information technology departments. One means of achieving this goal is to use a common software image across all computers in the organization. Unfortunately, it becomes difficult to create a common software image that will work on all of the organization's computers when many of those computers exhibit incompatible BIOS geometry translation.

### SUMMARY OF THE INVENTION

In one aspect, an implementation according to a preferred embodiment of the invention achieves software image portability automatically: A host computer reads geometric parameters from a data structure in a boot record of a disk device, the disk device containing a software image. The computer adopts those parameters as geometric translation parameters for use when accessing the software image. Thus, the implementation is able to determine and adopt a correct set of translation parameters without the need for intervention or data input by a computer user.

In another aspect, an implementation according to a preferred embodiment of the invention reads the Master Boot Record from a disk device; finds a usable entry in the partition table of the Master Boot Record; reads a sector specified by a Starting LBA field in the usable partition table entry; assigns a number of sectors per track equal to the word found at offset 18h in the BIOS Parameter Block of the sector; and assigns a number of heads equal to the word found at offset 1Ah in the BIOS Parameter Block of the sector. In a further aspect, an implementation according to a preferred embodiment of the invention may translate the value in a Starting CHS Address field of the usable partition table entry to an LBA-style address; and verify that the LBA-style address so calculated matches the value in the Starting LBA field.

### BRIEF DESCRIPTION OF THE DRAWINGS

FIG. 1 is a flow diagram illustrating a method for determining geometric translation parameters for a disk device according to a preferred embodiment of the invention.

FIG. 2 is a flow diagram illustrating a preferred method for determining whether a partition table entry is usable in the context of performing the method of FIG. 1.

### DETAILED DESCRIPTION OF THE PREFERRED EMBODIMENTS

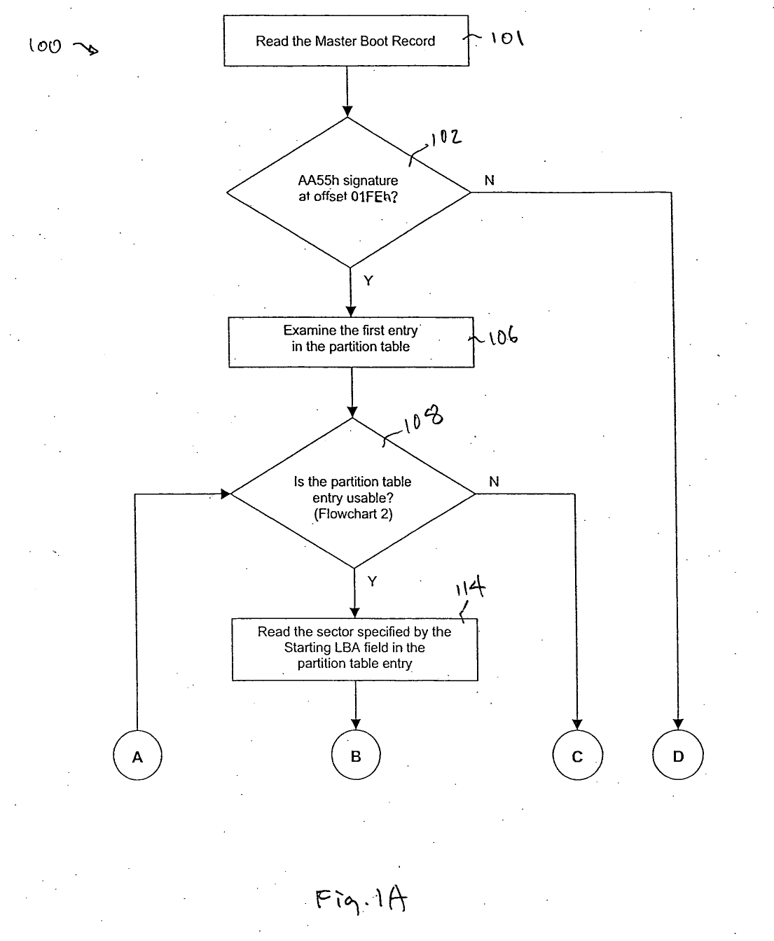

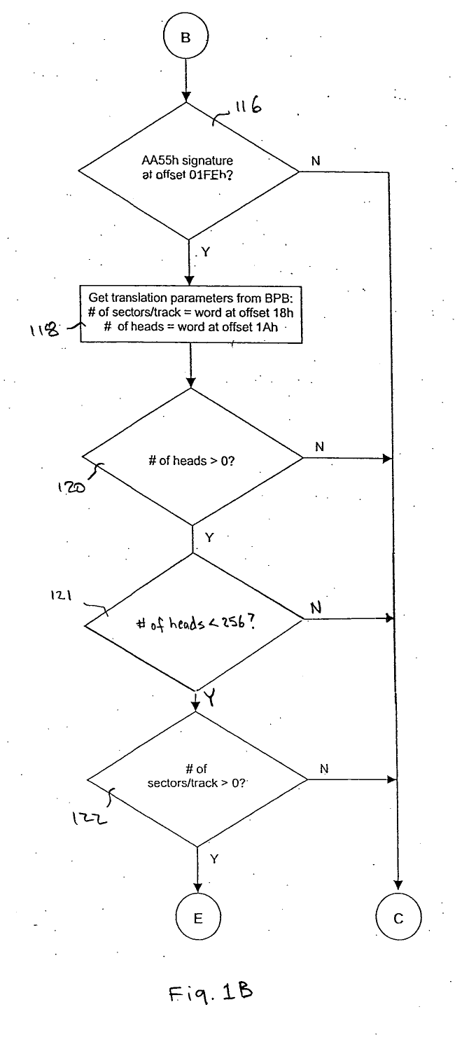

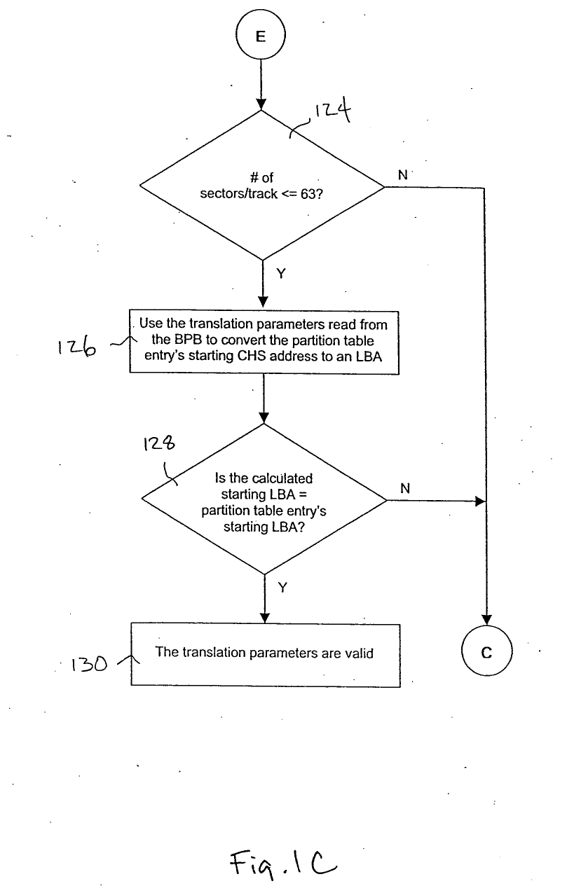

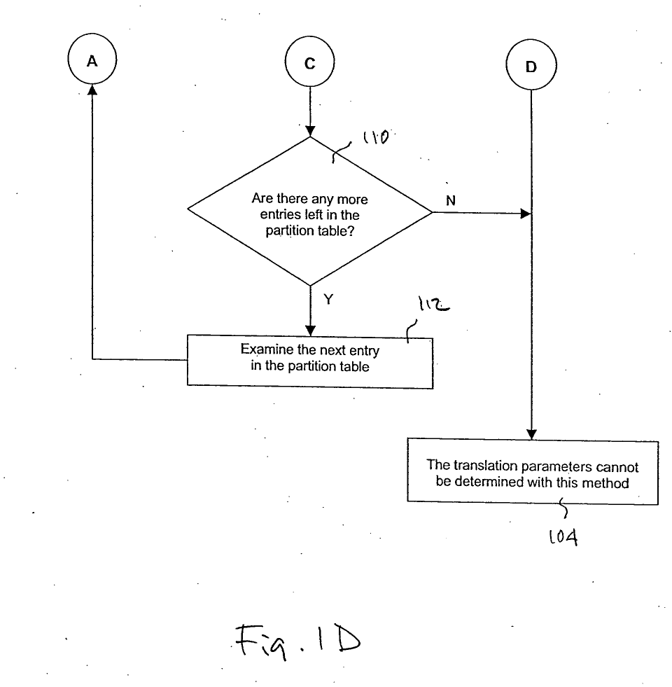

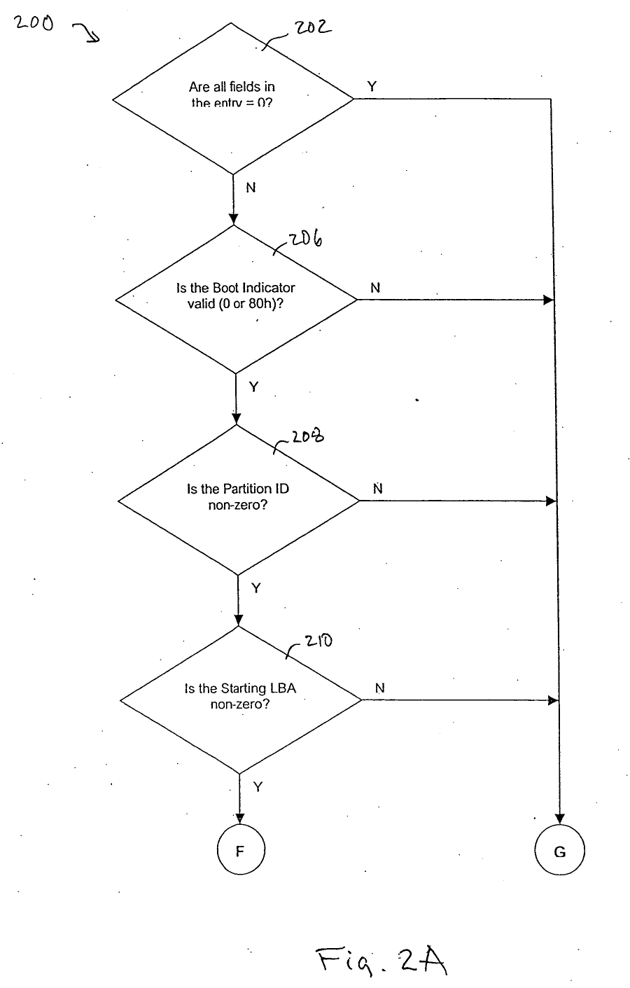

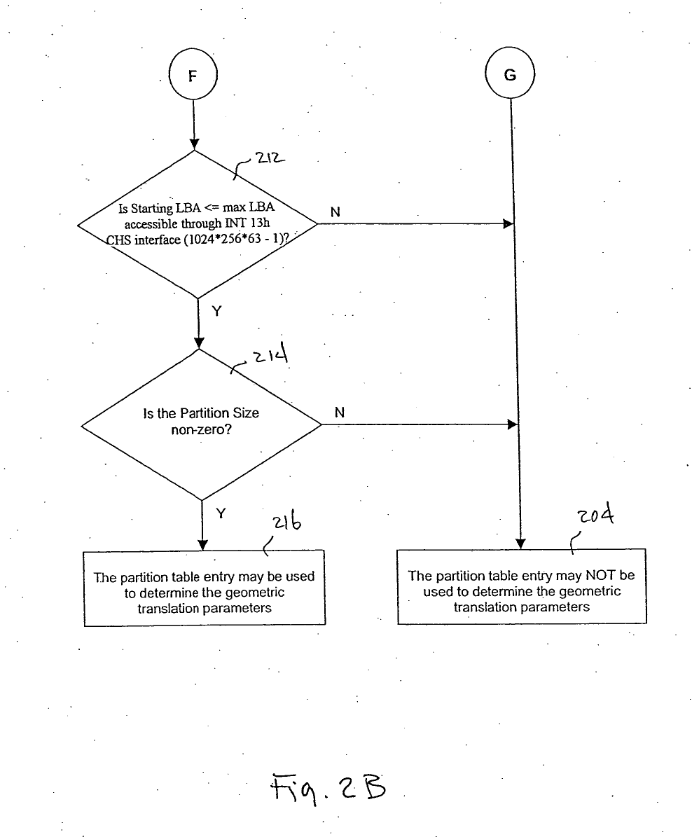

An implementation in accordance with the invention may achieve software image portability automatically by causing a host computer to read geometric parameters from a data structure in a boot record of a disk device containing a software image, and then causing the host computer to adopt the geometric parameters for use as geometric translation parameters when accessing the software image. The host computer may employ methods such as those illustrated in FIGS. 1 and 2 in order to extract the geometric parameters from the device and to determine whether the extracted parameters are suitable for use as geometric translation parameters. In a preferred implementation, the invention may be implemented in BIOS firmware for the host computer. In other embodiments, the invention may be implemented in other firmware, or in software or in hardware.

A method 100 will now be described for determining geometric translation parameters for a disk device. Step 101 reads the Master Boot Record from the device. This may happen, for example, when the host computer attempts to boot from the device. Step 102 checks the Master Boot Record for the AA55h signature that would be expected at offset 01FEh in any valid Master Boot Record. If the signature cannot be verified at that location, then step 104 concludes that geometric translation parameters cannot be determined from the device using method 100. (This condition may be handled by any suitable means, such as by indicating an error condition, or by continuing with a traditional BIOS boot sequence wherein an alternative boot device is chosen or user input is solicited.) If a proper signature is verified, then the method continues at step 106.

The partition table in the Master Boot Record may contain four possible entries. Steps 106, 108, 110, and 112 attempt to determine iteratively whether any one of the four partition table entries is usable for eliciting geometric parameters from the device. (A preferred method for determining whether a partition table entry is usable for this purpose will be described below with reference to FIG. 2.) In step 106, the first of the four entries is examined. If it is determined in step 108 that the first entry is not usable, then further entries are examined in the loop comprising steps 110, 112 and 108 until either a usable entry is found or all entries have been examined. If no usable entry has been found after all entries have been examined, then the method may terminate with step 104.

Assuming a usable partition table entry was found, execution continues with step 114. Step 114 reads, from the disk device, the sector that is specified by the Starting LBA field at offset 8 in the usable partition table entry. As step 116 indicates, this sector may be checked for a valid AA55h signature at offset 01FEh. If a valid signature is not found, then the method may terminate with step 104. Otherwise, step 118 reads geometric parameters from the BIOS Parameter Block of the sector. Specifically, a number of sectors per track variable is set equal to the word found at offset 18h in the BIOS Parameter Block, and a number of heads variable is set equal to the word found at offset 1Ah in the BIOS Parameter Block. As steps 120, 121, 122 and 124 indicate, an initial validity check may be performed on the extracted geometry parameters by ensuring that they are both greater than zero, that the number of heads variable is less than 256, and that the number of sectors per track variable is less than or equal to 63. If any of these initial validity checks fails, then the method may terminate at step 104. If the initial validity checks pass, then the method continues at step 126.

As a more substantive validity check, step 126 may use the extracted geometry parameters to translate the CHS-style value in the Starting CHS Address field at offset 2 of the usable partition table entry into an LBA-style address. This translation may be accomplished as follows: Let S equal the number of sectors per track value extracted from the BIOS Parameter Block, and let H equal the number of heads value extracted from the BIOS Parameter Block. And let c, h and s equal the cylinder, head and sector components, respectively, of the CHS-style starting address of the usable partition table entry. Then the LBA-style starting address of the usable partition table entry is: LBA=(cH+h)S+s−1.

To complete the validity check, step 128 determines whether the just-calculated LBA-style address is the same as the address that was found in the Starting LBA field of the usable partition table entry. If they are the same, then the method concludes in step 130 that the extracted geometry parameters are valid, and that they may be used as geometric translation parameters for the disk device during subsequent operations involving the device.

Referring now to FIG. 2, a preferred method 200 will now be described for determining whether a given partition table entry may be used in the context of the method of FIG. 1. Basically, method 200 is a series of six validity checks. If any of the checks fails, then the method may terminate in step 204 with the result that the partition table entry may not be used in the context of the method of FIG. 1. Step 202 checks whether all fields in the partition table entry are 0. If so, then the check fails. Step 206 checks whether the boot indicator of the partition table entry is a valid one. A valid boot indicator may have a value of 0 or a value of 80 h. If the boot indicator of the partition table entry contains either of these values, then the check passes. Step 208 checks whether the partition ID is non-zero. If so, the check passes. Step 210 checks whether the Starting LBA field of the partition table entry is non-zero. If so, the check passes. Step 212 checks whether the value of the Starting LBA field of the partition table entry is not greater than a valid maximum. Specifically, the step ensures that the Starting LBA address found in the partition table entry is less than or equal to the maximum LBA accessible through the interrupt 13h CHS addressing interface (1024*256*63−1). If so, the check passes. Finally, step 214 checks whether the partition size field of the partition table entry is non-zero. If so, the check passes, and the method may then terminate at step 216 with the result that the partition table entry may be used in the context of the method of FIG. 1.

1. A method for achieving software image portability automatically, comprising:
causing a host computer to read geometric parameters from a data structure in a boot record of a disk device containing a software image; and
causing the host computer to adopt the geometric parameters for use as geometric translation parameters when accessing the software image.

2. The method of claim 1, wherein:
the data structure is a Bios Parameter Block.

3. A method for determining geometric translation parameters for use with a disk device, comprising:
reading a Master Boot Record from the disk device;
finding a usable entry in the partition table of the Master Boot Record;
reading a sector specified by a Starting LBA field in the usable partition table entry;
assigning a number of sectors per track equal to a word found at offset 18h in a BIOS Parameter Block of the sector; and
assigning a number of heads equal to a word found at offset 1Ah in the BIOS Parameter Block of the sector.

4. A method according to claim 3, further comprising:
using the number of sectors per track and the number of heads so assigned, translating the value of a Starting CHS Address field of the usable partition table entry to an LBA-style address; and
verifying that the LBA-style address matches the value of the Starting LBA field.

5. A storage or transmission medium containing program code that, when executed by a computer, causes the computer to perform a method for achieving software image portability automatically, the method comprising:
reading geometric parameters from a data structure in a boot record of a disk device containing a software image; and
adopting the geometric parameters for use as geometric translation parameters when accessing the software image.

6. The storage or transmission medium of claim 5, wherein:
the data structure is a Bios Parameter Block.

7. A storage or transmission medium containing program code that, when executed by a computer, causes the computer to perform a method for determining geometric translation parameters for use with a disk device, the method comprising:
reading a Master Boot Record from the disk device;
finding a usable entry in the partition table of the Master Boot Record;
reading a sector specified by a Starting LBA field in the usable partition table entry;
assigning a number of sectors per track equal to a word found at offset 18h in a BIOS Parameter Block of the sector; and
assigning a number of heads equal to a word found at offset 1Ah in the BIOS Parameter Block of the sector.

8. The storage or transmission medium of claim 7, wherein the method further comprises;
using the number of sectors per track and the number of heads so assigned, translating the value of a Starting CHS Address field of the usable partition table entry to an LBA-style address; and
verifying that the LBA-style address matches the value of the Starting LBA field.

9. A computer configured to perform a method for achieving software image portability automatically, the method comprising:
reading geometric parameters from a data structure in a boot record of a disk device containing a software image
adopting the geometric parameters for use as geometric translation parameters when accessing the software image.

10. The computer of claim 9, wherein:
the data structure is a Bios Parameter Block.

11. A computer configured to perform a method for determining geometric translation parameters for use with a disk device, the method comprising:
reading a Master Boot Record from the disk device;
finding a usable entry in the partition table of the Master Boot Record;
reading a sector specified by a Starting LBA field in the usable partition table entry;
assigning a number of sectors per track equal to a word found at offset 18h in a BIOS Parameter Block of the sector; and
assigning a number of heads equal to a word found at offset 1Ah in the BIOS Parameter Block of the sector.

12. The computer of claim 11, wherein the method further comprises:
using the number of sectors per track and the number of heads so assigned, translating the value of a Starting CHS Address field of the usable partition table entry to an LBA-style address; and
verifying that the LBA-style address matches the value of the Starting LBA field.
